(19) United States
(12) Patent Application Publication
(10) Pub. No.: US 2010/0111792 A1
(43) Pub. Date: May 6, 2010

(54) Atmospheric molecular respirator

(76) Inventor: Edward D. Nelson, Manorville, NY (US)

Correspondence Address: Thomas A. O'Rourke;Bodner & O'Rourke, LLP, Suite 108, 425 Broadhollow Road, Melville, NY, 11747, US

(21) Appl. No.: 12/586,381

(22) Filed: Sep. 21, 2009

Related U.S. Application Data
(60) Provisional application No. 61/192,599, filed on Sep. 19, 2008.

(51) Int. Cl. B01J 19/08; B01D 53/34

(52) U.S. Cl. 423/219; 422/186.3

(57) ABSTRACT

An apparatus for removing contaminants from air, including nitrogen oxides, carbon monoxide, carbon dioxide, and sulphur dioxide. In one of the chambers of a multi-chambered enclosure, polluted inlet air is exposed to one or more first light sources emitting light at wavelengths less than or equal to 242.3 nm to cause dissociation of contaminant molecules, creating ozone plus remaining atoms. The remaining atoms are largely filtered by activated charcoal filters having an appropriate thickness which is sized to achieve suitable dwell times, and which also serves as an oxygen rich medium permitting the ozone generated to undergo atomic rearrangement, whereby ozone molecules (O₃) and atomic oxygen atoms (O) form oxygen molecules (O₂). In another downstream chamber, the air flow is exposed to one or more second light sources emitting light at wavelengths greater than 242.3 nm but less than 280 nm, causing conversion of remaining ozone into oxygen molecules.

This application claims priority on U.S. Provisional Application Ser. No. 61/192,599 filed on Sep. 19, 2008, the disclosures of which are incorporated herein by reference.

### FIELD OF THE INVENTION

The present invention relates to improvements in methods and apparatus for purifying air, and more particularly to such methods and apparatus which are specifically capable of removing pollutants that may be either particulate or gaseous in nature.

### BACKGROUND OF THE INVENTION

The air comprising earth's atmosphere supplies vital life-sustaining requirements for virtually all forms of life. Plants utilize the carbon-dioxide in the atmosphere, through the process of photosynthesis, to produce sugar in the presence of sunlight, and expel oxygen as a waste product. The gills of a fish provide a means for extraction of oxygen from ocean water as well as excretion of carbon dioxide as waste—a natural filtering system—while certain aquatic animals absorb adequate amounts of oxygen through the surface of their bodies. It is well-known that oxygen levels in ocean waters are tied to the oxygen in the atmosphere, despite the prolific oxygen-production capability of the ocean's phytoplankton.

The need for clean air for human respiration became an important issue after World War II, with concerns regarding radioactive fallout, and because of the effects of London's “Great Smog” of 1952, which is generally regarded as the most significant early air pollution episode in history, where over 100,000 became ill and hundreds of thousands were reported to have died prematurely due to the release of sulphur dioxide from burning low-grade coal. The U.S. Congress thereafter passed the Air Pollution Control Act of 1955, followed by a series of other “Clean Air Acts,” and in 1970, President Nixon signed the law creating the Environmental Protection Agency, which was to safeguard the natural environment—air, water and land.

While progress has been made, the U.S. and other nations—particularly China and India—still rely heavily on the coal-fired generating plant. These coal-burning plants emit lead, mercury, arsenic, and millions of tons of carbon dioxide and soot annually, which are known to drift thousands of miles. Even where governmental regulation effectively controls the output of effluents into the environment, the possibility of accidental release remains a threat, and is starkly illustrated by the industrial disaster in Bhopal, India, where some 42 tons of toxic pesticide gas was accidentally released, resulting in 3,787 confirmed deaths.

Pollutants affecting the ordinary American household daily may include industrial pollutants just described, as well as dust; pet dander; mold; pollen; plant spores; bacteria from bird droppings; tobacco smoke; and auto emissions in the form of unburned hydrocarbons, nitrogen oxides (NO, NO₂, N₂O, N₂O₃, N₂O₄—NOx), carbon monoxide, and carbon dioxide. Where ozone in the upper atmosphere is necessary to block cancer causing high energy ultraviolet light from the sun, automobile hydrocarbons can react in the presence of NOx to produce ground-level ozone, which itself is carcinogenic.

The human body has some inherent tolerance to pollutants, and the hair in the anterior nasal passage plus cilia in the nasal cavity—which transports mucus—even serve to filter certain particulates from the air that enters a person's lungs. But many pollutants, including ozone, while possibly not concentrated enough to cause death or cancer, may cause respiratory disease, cardiovascular disease, throat inflammation, chest pain, congestion, and other ailments. So it is not surprising that there are many U.S. patents pertaining to air purification.

There is wide range of techniques that have resulted in the issuance of patents, such as U.S. Pat. No. 3,747,300 to Knudson. The Knudson approach uses three filters—“a mechanical filter element . . . , an activated charcoal filter element . . . , and an electrostatic air precipitator filter element.” The mechanical and charcoal filters provide conventional filtering, and the electrostatic air precipitator contains charging electrodes that electrically charge particles, which are then removed by electrostatic attraction to the collecting electrodes. Similarly, filtering according to U.S. Pat. No. 4,980,796 to Huggins occurs with an electric field generated by a charged screen that emits charged electrons, and “by ionizing the particulate which then flows to the floor under gravitational and/or electrostatic forces.”

Purification according to U.S. Pat. No. 4,337,071 to Yang occurs when an “apparatus that produces cryogenic temperatures is used to remove, by condensation, all pollutants in the air.” U.S. Pat. No. 4,210,429 to Goldstein provides a room air purifier in the form of “a high efficiency filter disposed in the housing for trapping small particles down to 0.3 microns” and “at least one ultraviolet lamp means disposed therein for killing viruses and bacteria flowing through the germicidal chamber.”

Many of these techniques serve to either filter particles, including the HEPA filter of U.S. Pat. No. 5,225,167, and/or provide ultraviolet germicidal lamps. Far less numerous are issued patents which address gaseous pollution instead of particulates.

Not surprisingly, some of the prior art has dealt with unwanted gaseous contaminants being removed by using the natural process whereby plants take up carbon dioxide and give off oxygen. U.S. Pat. No. 5,180,552 to Saseman provides for passing of room air up through potting soil, which contains carbon granules and sphagnum moss, and through the root system of living green plants, and claims to effectively remove “compositions from the class consisting of aliphatic and aromatic aldehydes and ketones, halogenated hydrocarbons, and cyclic hydrocarbons.”

In a more time-efficient process, U.S. Pat. No. 5,908,494 to Ross includes a spray purification apparatus to inject an “acid-neutralizing alkali aqueous solution” which is used “to wash the contaminants from the airstream, followed by a mechanical drying of the washed airstream.” The apparatus claims effectiveness in the removal of “nitrogen oxides, sulfur dioxide, hydrogen sulfide, hydrochloric acid, carbon dioxide, carbon monoxide and ozone.” This process, however, requires necessary supporting apparatus of a fluid flow system for the aqueous solution in order to accomplish the spraying, drainage, and recirculation, making the system relatively complex and not autonomous due to the professional servicing that would regularly be required.

The invention disclosed herein accomplishes cleansing of particulates and gaseous contaminants for a high volume of air in a robust, easily maintained system.

### OBJECTS OF THE INVENTION

It is an object of the invention to provide a means for purifying air.

It is another object of the invention to provide a method for removal of particulates from room air.

It is a further object of the invention to provide a process to remove gaseous contaminants from room air.

It is another object of the invention to provide a robust method of air purification capable of purifying substantial volumes of room air.

It is also an object of the invention to provide a purification system that is and easy to maintain.

### SUMMARY OF THE INVENTION

An apparatus for removing contaminants from air, including nitrogen oxides, carbon monoxide, carbon dioxide, and sulphur dioxide is disclosed. Polluted air may enter a first chamber through an inlet port. The first chamber, and all of the succeeding chambers, may contain sensors to measure certain properties of the incoming air flow, such as air flow rate in cubic feet per minute (CFM), inlet pressure, static pressure, pressure differentials, temperature, and relative humidity. The first chamber leads to a first activated charcoal filter which may filter particulate matter. The first activated charcoal filter also serves as the interconnection to a second chamber in which a plurality of first lamp sources is mounted. The air is therein exposed to light at wavelengths less than or equal to 242.3 nm to cause dissociation of contaminant molecules, creating ozone plus remaining atoms.

Dissociation is a process in which ionic compounds separate or split into smaller molecules, ions, or radicals. The process involves a disconnection of the bonds between atoms that hold a molecule together, and may occur only when the energy contained within a photon is released. But to achieve dissociation, the wavelength of light used must be selected to deliver photons that are compatible with the target contaminant molecules. A non compatible sized photon will not disassociate the bonds between the target molecules.

The flow of air, including the ozone plus remaining atoms resulting from dissociation, travel to the end of the second chamber and pass through a second activated charcoal filter. The remaining atoms are largely filtered by the second activated charcoal filter. The second activated charcoal filter is sized to have an appropriate thickness so as to achieve suitable dwell times of the air flow therein, to enable sufficient time for absorption of the remaining atoms. The second activated charcoal filter also serves as an oxygen rich medium, permitting the ozone generated in the second chamber to undergo atomic rearrangement through the process of molecular respiration. Atomic rearrangement of the ozone occurs with ozone molecules (O₃) and atomic oxygen atoms (O) combining to form oxygen molecules (O₂).

The second activated charcoal filter is also the interconnection to the third chamber, in which the air flow is then exposed to one or more second light sources. These second light sources emit light at wavelengths greater than about 242.3 nm but less than about 280 nm, which causes conversion of any remaining ozone into oxygen molecules. The air flow may pass through a third activated charcoal filter for system redundancy to further filter any remaining atoms and ensure that the pollution is eliminated. The third activated charcoal filter interconnects to a fourth chamber, which comprises an outlet port, as well as additional sensors. These sensors may also measure air flow rate, velocity, temperature, relative humidity, and pressure, but can also be used to measure any residual pollution in the purified air flow, which, when compared to pollution levels of the inlet air flow, would serve to identify system efficiency and provide notice for when maintenance of the apparatus may be needed, particularly for replacement of the activated charcoal filters and for the lamps. Sensors may be located in any or all of the chambers to provide data on pressure drops, as well as to provide data on lamp intensity.

The invention may be housed in a straight-line set of chambers in the form of a rectangular enclosure or a tubular duct. Alternatively, the invention could be configured to save space by having a bend after the second chamber, leading into the third and fourth chamber. Also, a blower may be incorporated to boost air flow, and additional lamps may be mounted to the interior of any enclosure to increase exposure of the air flow to the wavelength-specific light.

### BRIEF DESCRIPTION OF THE DRAWINGS

FIG. 1 is a cross-sectional view of a first embodiment of the present invention.

FIG. 1A is a cross-sectional view of an alternate embodiment of the present invention.

FIG. 2 is a cross-sectional view of a second embodiment of the present invention, having air dispersible baffles.

FIG. 3 is a cross-sectional view of the third embodiment of the present invention, having an internal array of additional light sources.

FIG. 4 is a cross-sectional view of the fourth embodiment of the present invention, having a blower.

FIG. 5 is section cut through the blower of the fourth embodiment shown in FIG. 3.

FIG. 6 is cross-sectional view of a fifth embodiment.

### DETAILED DESCRIPTION OF THE INVENTION

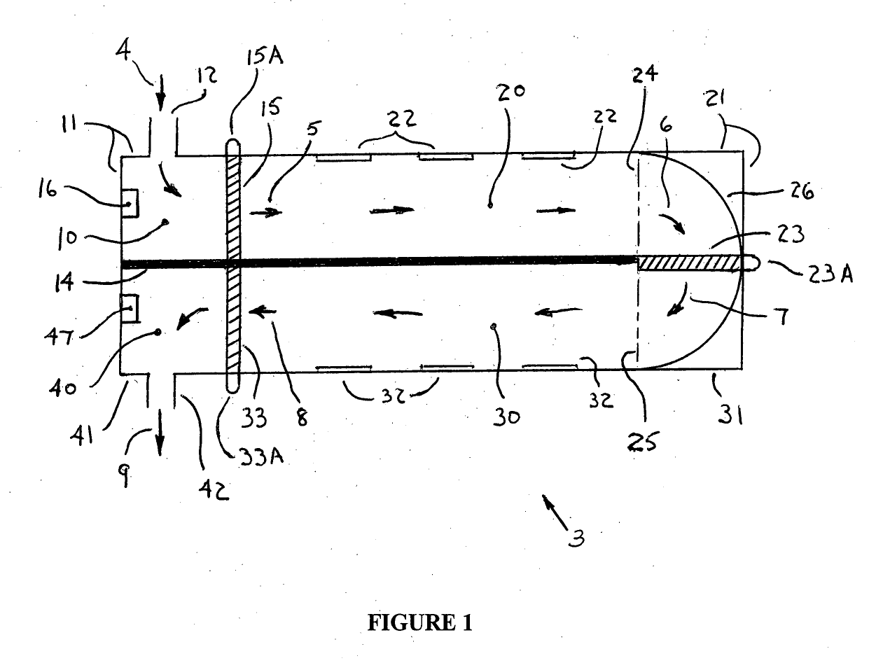

FIG. 1 shows a first embodiment incorporating principles of the Atmospheric Molecular Respirator of the present invention. The apparatus 3 is capable of removing contaminants from air by using both physical and chemical principles that will be discussed herein at the corresponding stage of the first embodiment.

The apparatus 3 comprising a first embodiment may have a first chamber 10 that is formed by one or more walls 11. It should be pointed out that first chamber 10, as well as the entire apparatus 3 may be formed with various shaped walls to constitute a duct capable of containing a flow of air. The principles of this invention may be utilized regardless of the shape of the air-conducting enclosure, which may have, but is not limited to, a rectangular-shaped cross-section forming a box-like enclosure, or a circular-shaped cross-section that forms a tubular enclosure. The discussion for the first apparatus 3 will proceed with a description of the enclosure as a plurality of walls 11, which may be considered, to aid the reader when looking at FIG. 1, as creating a rectangular-shaped chamber 10.

The plurality of walls 11 may include an inlet port 12 through which an inlet air flow 4 may be received into the apparatus 3. Inlet airflow 4 would constitute contaminated indoor/outdoor air being introduced into the apparatus 3 for purification. The plurality of walls 11 may include a solid baffle plate 14 that is without any openings so as to serve as a separation wall between first chamber 10 and other subsequent chambers, and thereby prevents intermingling of any of the discrete air flows herein described. The plurality of walls 11 forming chamber 10 should be sized and generally designed to ensure good air flow and air distribution for the particular service conditions. It should be pointed out that the principles of this invention may be incorporated for use in homes, industrial facilities, office buildings, automobiles, aircraft environmental control systems, and more generally into any heating/ventilating or air conditioning (HVAC) system. More particularly, apparatus 3, or any of the other embodiments offered herein, may be incorporated into a new building or added to an existing building to purify the outside air being drawn in for use by the occupants. In addition, the apparatus could be installed to the tops of buildings to purify air in major metropolitan areas that typically experience serious smog problems.

Chamber 10, as well as each of the other chambers discussed hereinafter that may follow chamber 10, may contain a plurality of sensors 16 to measure certain aspects of the incoming air flow 4, such as air flow rate in cubic feet per minute (CFM), inlet pressure, static pressure, pressure differentials, temperature, relative humidity, and lamp intensity. It would also be beneficial, in order to provide adjustments to the air flow rate and corresponding air dwell time per chamber, to have sensors measuring pollution levels in parts per million (ppm) for both the incoming air 4 and the purified air.

The plurality of walls 11 of chamber 10 may also include a first filter 15, positioned in the only air-permeable exit of first chamber 10 through which air flow 4 can pass. First filter 15 is optional. However, first filter 15, which may preferably be a carbon-based filter more preferably an activated charcoal filter, would serve to filter particulate matter at this stage, before the air flow undergoes purification. It is well known that a charcoal filter, being a form of carbon that has been processed to have high porosity, serves effectively to filter certain elements and particulates. Activated charcoal is charcoal that has been treated with oxygen to enhance its porosity. Filtration in the activated charcoal filter occurs by the high porosity providing bonding sites to attract and “absorb” chemicals. Once the filter has been in service for an extended period of time, all of the bonding sites may become full, and the filter will no longer attract and remove impurities from the air flow, at which time the filter should be replaced. Therefore, if apparatus 3 incorporates a first activated charcoal filter 15 and any other such filters, provisions must be made for its ease of installation and subsequent replacement into the plurality of walls 11 and solid baffle plate 14. Activated charcoal filter 15 is shown in FIG. 1 with an external handle 15A, permitting easy access to and removal of the activated charcoal filter 15 without disassembly of the apparatus 3.

The first activated charcoal filter 15, as incorporated into apparatus 3, filters particulates from inlet air flow 4 to produce first filtered air flow 5. First activated charcoal filter 15, as incorporated into apparatus 3, interconnects the first chamber 10 to the second chamber 20, by providing the porous pathway. A different embodiment, which does not have first activated charcoal filter 15, would essentially have chamber 10 and second chamber 20 being merged into a single chamber. Chamber 20 may be considered to be formed of a plurality of walls 21, however, it may also be seen in FIG. 1 that the plurality of wall constituting the first chamber may simply extend to produce the second and subsequent chambers, and in fact, all of the apparatus 3 walls could actually be formed of a single continuous curved wall.

The second chamber 20 has one or more walls 21. A first activated charcoal filter 15 may be considered as forming one of a plurality of walls 21 of said second chamber 20. Additionally, solid baffle plate 14 may also extend beyond first chamber 10 to serve as one of the walls of second chamber 20, and thus continues to serve as an air-flow separation wall, separating second chamber 20 from the third chamber 30, which follows second chamber 20.

One of the key features of this invention is the light sources found in second chamber 20. Second chamber 20 incorporates one or more first light sources 22 that emit light only at specified wavelengths. Positioning one or several first light sources 22 that only emit a mid-range violet light, having wavelengths of less than or equal to 242.3 nm, will cause dissociation of targeted contaminant molecules.

Dissociation is a process in which ionic compounds—complexes (a “coordination compound” or “metal complex”), molecules, or salts—separate or split into smaller molecules, ions, or radicals. The process involves a dissociation of the bonds between atoms that hold a molecule together, and may occur only when the energy contained within a photon is released. To trigger this release, the photon must strike a molecule capable of absorbing the photon's energy.

To achieve dissociation, the wavelength of light used must be selected to deliver photons that are compatible with the target contaminant molecules. A non compatible sized photon will not disassociate the bonds between the target molecules. The appropriate wavelength of light that will cause dissociation is the size of the largest single photon the molecule could possibly carry, based on the energy it can absorb, to “excite” the atomic particles within the molecule. Too large of a photon can result in production of heat, radio waves, visual light, gamma rays, etc. The relationship between energy and frequency is referred to as Planck's Relation or the Planck-Einstein Equation: E=hv, where v is the frequency of the radiation, and h is Planck's constant whose units take the form of energy multiplied by time. Planck's constant is, in various different units, 6.62606896(33)×10⁻³⁴ J·s (Joule-seconds), or 4.13566733(10)×10⁻¹⁵ eV·s (electron volt-seconds), or 6.62606896(33)×10⁻²⁷ erg·s (erg-seconds). As an example, the energy of a 200 nm photon is thereby determined to be 10 to the minus 18^{th} power (10⁻¹⁸). The light wavelengths selected to shine and produce dissociation of the chemical bonds of the contaminant molecules here will be 242.3 NM or smaller, which comprises only a fraction of the conventional UVC light (wavelengths of 280 nm-100 nm) that is often utilized for its germicidal effect (where UV long wave begins at 400 nm and generally runs down to 10 nm, and has energies from 3 eV to 124 eV).

In particular, in second chamber 2 of a first embodiment, there will be treatment of inorganic compounds, accomplished by dissociation of molecules that includes, but is not limited to, NOx, CO, CO₂, and SO2, which will result in the formation of ozone (O₃) and remaining atoms. In an alternate embodiment, the air may be treated to so as to only treat one or more specific chemicals from the group consisting of NOx, CO, CO₂, and SO₂.

Once the largest usable wave length of light that will produce the desired molecular respiration is known, which here will be 242.3 nm or smaller, lamp sources can be considered. First light source 22 could be a laser with compressed wavelengths, to shorten the spike and spreads its wavelength, and so have a wider range with a lesser intensity. The lamp source that today seems to be most efficient and economic is a mercury arc lamp, which may preferably be used in a preferred embodiment.

Exposure of first filtered air flow 5 to a plurality of first lamp sources 22 in the first embodiment produces the dissociated air flow 6, which includes both the formed ozone and the remaining atoms. It may be seen by looking at FIG. 1 that first filtered air flow 5 must traverse the full length of second chamber 20 and therein repeatedly undergo illumination by the appropriate wavelength of light being emitted from a series of lamp sources, resulting in air flow which may not avoid lengthy exposure and treatment. The plurality of walls 21 of said second chamber 20 may also comprise a second activated charcoal filter 23 to serve as the primary filter of the invention. Second activated charcoal filter 23 may also include an external handle 23A for easy access to and removal of the filter. The second activated charcoal filter 23 acts on the former pollutants now in their new form as free radicals, atoms which previously could not be removed from the air, but are now in a vulnerable state, and will be scrubbed from the dissociated air flow 6 as it passes thru the primary activated charcoal filter 23. Exiting the second activated charcoal filter 23 will be the scrubbed air flow 7.

Selection of the appropriate size activated charcoal filter is important for several reasons. The filter should be sized for a thickness that provides a minimal practical service life in terms of months or years of usage, and also provides the minimum thickness to produce suitable dwell times of the air to ensure that this process critical event reaches completion. Additionally, sizing of the filter must address the service conditions including, but not limited to, velocity and air flow rate. A benefit of a thicker filter is that it reduces the frequency of filter replacements needed and offers redundancy, lower maintenance costs, and less down time. Alternatively, a thinner filters benefits the draft inducer with a lower demand by placing a lower static pressure resistance or pressure differential across the filter for the same CFM and orifice size, than a filter of greater thickness. But a thinner filter will require more frequent replacements and or wash downs.

Another useful effect of second activated charcoal filter 23 is that the ozone that was generated during the second chamber 20 will exchange atoms within the filter, resulting in the atomic rearrangement of the ozone molecule (O₃) and atomic oxygen atoms to form oxygen molecules (O₂).

Second activated charcoal filter 23 serves to interconnect the second chamber 20 to a third chamber 30. The third chamber 30 may be formed of a plurality of walls 31, of which the second activated charcoal filter 23 comprises one of the walls, along with solid baffle plate 14. The third chamber 30 may incorporate one or more second light sources 32. The second light source 32 is selected to emit light at wavelengths greater than 242.3 nm but less than 280 nm. This range of light wavelength is selected as it will cause conversion of ozone into oxygen, so any ozone atoms not converted to oxygen molecules within the activated charcoal filter 23 will be acted upon. Should the wavelengths utilized approach a size greater than 280 nm, heat will also begin to develop proportionately as the increased size of the photons excite molecules being treated.

Looking at FIG. 1, it can be seen that second activated charcoal filter 23 may be positioned as shown, and thus extend outward from solid baffle plate 14, or could alternatively be replaced by an alternate activated charcoal filter 24, and/or an alternate activated charcoal filter 25. Also, alternate activated charcoal filter 24 and alternate activated charcoal filter 25 could be integrated to form a single larger activated charcoal filter and thus provide redundant filtering of dissociated air flow 6. To reduce losses in the air flow rate in the apparatus 5, second chamber 20 and third chamber 30 may each contain curved inner wall 26 that redirects the path of the air flow.

As seen in FIG. 1, the second light source 32 may be a plurality of lamps that are mounted in succession across the length of one of the plurality of walls 31 to increase exposure of the remaining ozone molecules in the scrubbed air flow 7, and produce the converted air flow 8. Converted air flow 8 may be subjected to a third activated charcoal filter 33 for system redundancy to further filter any remaining atoms and ensure that the pollution is eliminated. Third activated charcoal filter 33 may also include an external handle 33A for easy access to and removal of the filter. Exiting the third activated charcoal filter 33 will be purified air flow 9.

The third activated charcoal filter 33 also serves to interconnect third chamber 30 and a fourth chamber 40. Fourth chamber 40 serves as an outlet chamber and is comprised of a plurality of walls 41 of which the third activated charcoal filter 33 may serve as one of these walls. The plurality of walls 41 of the fourth “outlet” chamber 40 may also include an outlet port 42. Chamber 40 may also have sensors 47, which are comparable to sensors 16 in first chamber 10 as previously described. Sensors 47 may also measure air flow rate, velocity, temperature, relative humidity, and pressure. Furthermore, sensors 47 may be used to measure any residual pollution in the purified flow 9, which would serve to identify system efficiency, and provide notice for when maintenance of the apparatus 5 may be needed, particularly for replacement of the activated charcoal filters, but also for the lamps. The sensors providing measurements of both inlet and residual pollution levels may also be utilized to adjust the intensity of light being emitted from the lamps 22 and 32 to optimize treatment where there are higher pollution levels or greater flow rates of air due to higher demand.

In another alternate embodiment 3A, shown in FIG. 1A, outer wall filters 27 may be located adjacent lamps 22, or may immediately follow lamps 22 in chamber 20 to draw off purified air before certain target pollutants may reconstitute themselves in the chamber. In one embodiment the filters may be positioned on the wall to surround the lamps. The purified air that is drawn off may continue to flow through outer conduit 28. Similarly, outer wall filters 37 may also immediately follow lamps 32 in chamber 30 to draw purified air into the outer conduit 28. Outer conduit 28 may terminate in a secondary outlet port 38, which may interconnect with outlet port 42. Alternate embodiment 3A lends itself to a generally radial arrangement of the chambers, lamps, and filters—possibly being a single filter—where the embodiment may have advantageous uses in automotive and other similar applications having air flow rates much lower than that which is required for large buildings.

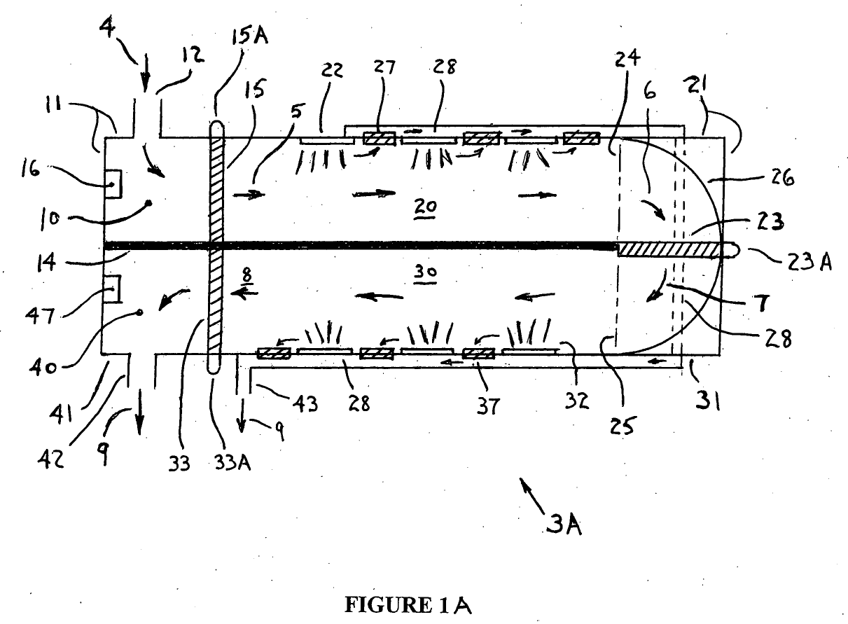

A second embodiment of the present invention is shown by apparatus 103 in FIG. 2. Apparatus 103 incorporates all of the essential elements of apparatus 3, but occupies a different shape by having the chambers formed in a straight line. Such an arrangement may trade off compactness in the design of the unit, while achieving greater efficiency.

Apparatus 103 may be formed of ducting having a rectangular cross-section, but may also preferably be formed with a cylindrical exterior wall 111 having a first end cap 113 and a second end cap 114 (FIG. 2). First end cap 113 may have an inlet port 112 to receive inlet airflow 104, and second end cap 114 may have an outlet port 142. Apparatus 103 may also have a first chamber 110, second chamber 120, third chamber 130, and a fourth chamber 140 serving the same functions as first chamber 10, second chamber 20, third chamber 30, and fourth chamber 40 of apparatus 3, wherein they are separated by first activated charcoal filter 115, second activated charcoal filter 123, and third activated charcoal filter 133. Second chamber 120 may have one or more first light sources 122, emitting light at wavelengths of less than or equal to 242.3 nm, the same as first light source 22 of apparatus 3, while third chamber 130 may have one or more second light sources 132, emitting light at wavelengths greater than 242.3 nm but less than 280 nm, the same as second light source 31 of apparatus 3.

With apparatus 103 so constructed, all of the processes—the dissociation of contaminant molecules of a first filtered air flow 105, the filtering of remaining atoms from the dissociated air flow 106 to produce scrubbed air flow 107, the conversion of ozone into oxygen molecules constituting converted air flow 108, and the final filtering to achieve purified air flow 109—are all comparable to those described for apparatus 3.

Apparatus 103 may additionally incorporate, into first chamber 110, a plurality of air dispersible baffles 150. The plurality of air dispersible baffles 150 may serve to direct the air flow into a more evenly distributed flow across the periphery of first activated charcoal filter 115, than might be otherwise obtained from the inlet air flow 104 of the small inlet port 112.

Also, in an alternate embodiment of apparatus 103, first chamber 120 and second chamber 130 may be combined so that both the first and second lamp sources are illuminating the air flow in a single enclosure.

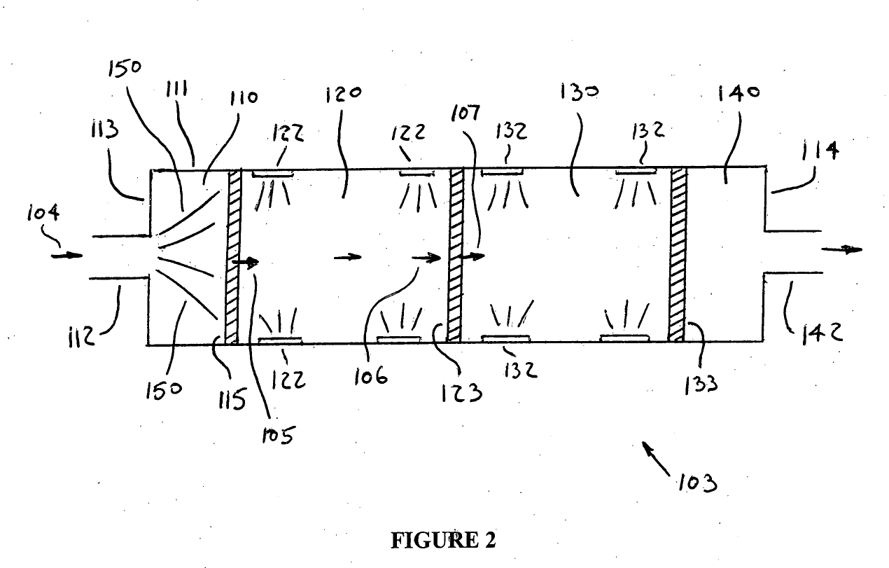

A variation of the apparatus 103 may create a third embodiment of the invention (FIG. 3), in the form of apparatus 203, which may also have member 160 running along the axis of the cylinder that forms cylindrical wall 111. Axis member 160 may generally be supported by posts extending from cylindrical wall 111 (not shown). Axis member 160 so added to apparatus 103 would permit the mounting of an additional array of first light sources 122 in second chamber 120, and additional second light sources 132 in third chamber 130.

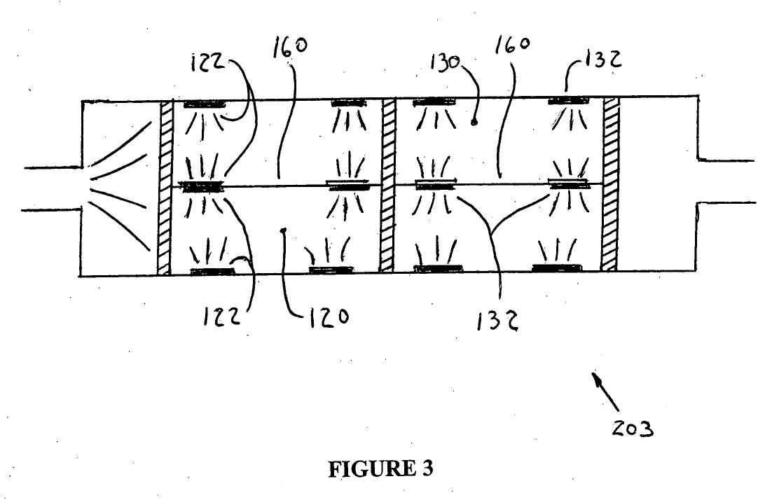

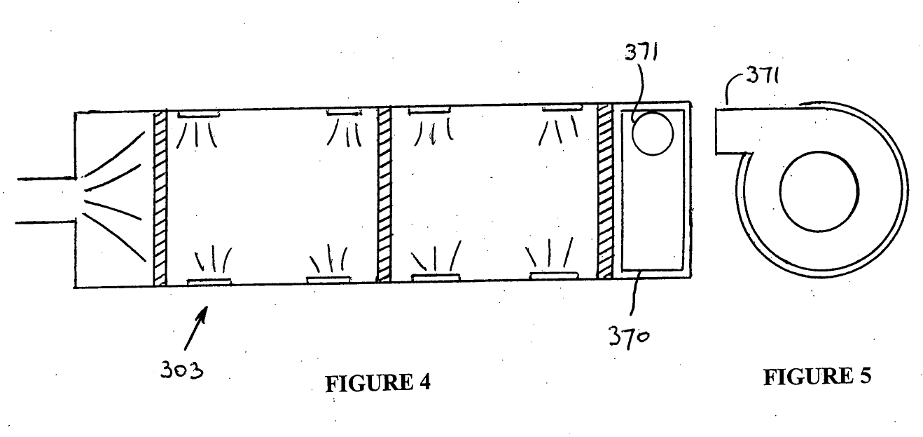

Another variation of the apparatus 103 may create a fourth embodiment shown by apparatus 303 in FIGS. 4 and 5, which additionally incorporates a fan or blower 370, having a blower outlet duct 371. The fan/blower 370, although shown in the fourth chamber of apparatus 303, could also be located in any one of the other chambers as well. The fan/blower 370 may be incorporated into the apparatus 303 to counter reductions in flow rates due to pressure drops resulting from appropriately sized activated charcoal filters, as well as deviation from pressure experience under standard atmospheric conditions. Thus; the fan/blower 370 may work in conjunction with the sensors that may be located in each of the chambers to calibrate the air flow rate, so as to ensure sufficient exposure time to the wavelength-specific light in each chamber.

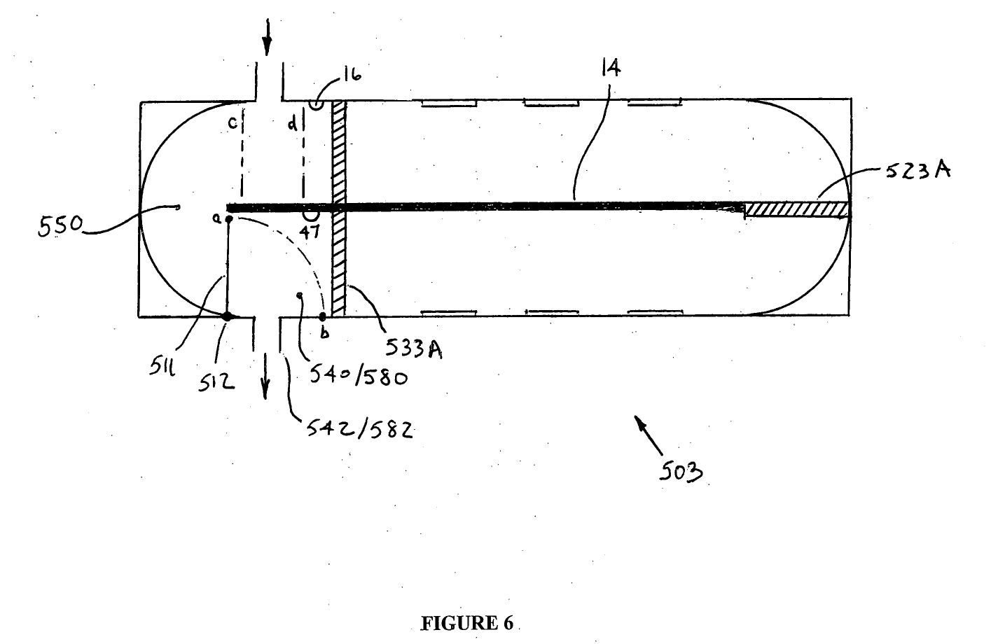

Finally, another variation of the apparatus 103 may create fifth embodiment in the form of apparatus 503, as shown in FIG. 6. Apparatus 503 may be constructed exactly like apparatus 103 except it includes a fifth chamber 550 that is creating by inclusion of a moveable plate 511 which has a pivotal attachment 512 to one of the walls of the fourth chamber 540. When sensors 16 and 47 determine that there is a significant reduction in the contaminants contained in the purified air, indicating proper functioning of the lamps and filters, but there still remains a high level of contamination in the treated air due to an inordinately high level of pollution in the incoming air, the sensors may trigger an actuation means (not shown) to rotate moveable plate 511. The free end of moveable plate 511 may be rotated from position “a,” where it abuts the solid baffle plate 14, to position “b,” where it abuts one of the walls of fourth chamber 540 and simultaneously blocks air flow out of outlet port 542, while creating an opening into fifth chamber 550. Fifth chamber 550 may contain a curved wall, beginning approximately at the position “c” phantom line and ending approximately at the position “d” phantom line, to transition the air flow into a series of chambers adjacent to second chamber 520, third chamber 530, and fourth chamber 540, in creating a redundant purification cycle which may be triggered only when necessary, by the high pollution levels sensed. The adjacent chambers—560, and 570—may be separated by a UV opaque liner that permits transmission of the UV light from the corresponding adjacent chambers—520 and 530. Additional UV lamps emitting appropriate wavelengths may also be included in the chambers 560 and 570. Chambers 560 and 570 may have an interconnection between them, similar to chambers 520 and 530, in the form of an activated charcoal filter 523A, and seventh chamber 570 may, interconnect through an activated charcoal filter 533A into an outlet chamber 580. Outlet chamber 580 may have an outlet port 582, which would supply twice-scrubbed air to the home or building into which the apparatus 503 is installed.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention as described in the following claims.

What is claimed is:

1. An apparatus for removing contaminants from air, said apparatus comprising at least a first chamber, said first chamber comprising one or more first light sources, said one or more first light sources providing light at wavelengths of less than or equal to 242.3 nm; a filter; and a second chamber, said second chamber comprising one or more second light sources, said one or more second light sources providing light at wavelengths of greater than 242.3 nm but less than or equal to 280 nm, said second chamber with said one or more second light sources being located downstream of said filter.

2. The apparatus for purifying air according to claim 1 wherein said filter comprises an activated charcoal filter, said activated charcoal filter having a handle for removal of said filter from said apparatus.

3. The apparatus for purifying air according to claim 1 wherein said one or more first light sources comprises a mercury arc lamp.

4. The apparatus for purifying air according to claim 1 wherein said one or more first light sources comprises a laser.

5. The apparatus for purifying air according to claim 2 wherein said apparatus includes a blower.

6. The apparatus for purifying air according to claim 2 wherein said apparatus includes one or more sensors in said one or more chambers.

7. The apparatus for purifying air according to claim 6 wherein said one or more sensors is capable of measuring one or more of the pollution levels, air flow rate, velocity, temperature, relative humidity, and inlet pressure.

8. The apparatus for purifying air according to claim 7 wherein said apparatus further comprises a series of air dispersible baffles.

9. An apparatus for removing contaminants from air, said apparatus comprising a first chamber, said first chamber comprising one or more walls, said first chamber including an inlet port, and a first activated charcoal filter; said first activated charcoal filter interconnecting said first chamber to a second chamber, said second chamber comprising one or more walls; said second chamber further comprising one or more first light sources, said one or more first light source emitting light at wavelengths of less than or equal to 242.3 nm to cause dissociation of contaminant molecules to create ozone and remaining atoms; said second chamber including a second activated charcoal filter; said second activated charcoal filter acting to filter said remaining atoms; said second activated charcoal filter also permitting atomic rearrangement of ozone into oxygen molecules; said second activated charcoal filter interconnecting said second chamber to a third chamber, said third chamber comprising one or more walls, said second activated charcoal filter comprising one of said plurality of walls of said third chamber; said third chamber further comprising one or more second light sources, said one or more second light sources emitting light at wavelengths greater than 242.3 nm but less than 280 nm to cause conversion of ozone into oxygen molecules; said third chamber further comprising a third activated charcoal filter; said third activated charcoal filter interconnecting said third chamber to a fourth chamber, said fourth chamber comprising one or more wall, including an outlet port.

10. The apparatus for purifying air according to claim 9 wherein said first chamber is adjacent to said fourth chamber and wherein said first chamber and said fourth chamber are completely separated by a baffle plate; and said second chamber is adjacent to said third chamber, and wherein, said second chamber and said third chamber are completely separated by said baffle plate.

11. The apparatus for purifying air according to claim 9 wherein said one or more first light sources and said one or more second light sources comprises a mercury arc lamp.

12. The apparatus for purifying air according to claim 9 wherein said one or more first light sources and said one or more second light sources comprises a laser.

13. The apparatus for purifying air according to claim 9 wherein said apparatus includes a blower.

14. The apparatus for purifying air according to claim 11 wherein said apparatus includes one or more sensors in said first chamber.

15. The apparatus for purifying air according to claim 14 wherein said apparatus includes one or more sensors in said fourth chamber.

16. The apparatus for purifying air according to claim 15 wherein said one or more sensors is capable of measuring one or more of the pollution levels, air flow rate, velocity, temperature, relative humidity, and inlet pressure in said first chamber and said fourth chamber.

17. The apparatus for purifying air according to claim 16 wherein said apparatus further comprises a series of air-dispersing baffles.

18. The apparatus for purifying air according to claim 17 wherein said activated charcoal filter includes a handle for removal of said filter from said apparatus.

19. The apparatus for purifying air according to claim 18 wherein said apparatus further comprises a pivotally mounted plate, said pivotally mounted plate occupying a first position to form one of said one or more walls of said fourth chamber, said pivotally mounted plate capable of rotating to a second position wherein said outlet port is blocked; said apparatus further comprising a fifth chamber, said fifth chamber being connected to said fourth chamber when said pivotally mounted plate is in said second position, said fifth chamber being interconnected to a sixth chamber by an activated charcoal filter, said sixth chamber being adjacent to said second chamber and being thereby separated by a liner, said liner being non-air-permeable and said liner being opaque to said light at wavelengths of less than or equal to 242.3 nm; said sixth chamber interconnecting to a seventh chamber by an activated charcoal filter, said seventh chamber being adjacent to said third chamber and being thereby separated by a second liner, said second liner being non-air-permeable and said second liner being opaque to said light at wavelengths greater than 242.3 nm but less than 280 nm, said seventh chamber interconnecting to an eighth chamber have an outlet port.

20. An apparatus for removing contaminants from air, said apparatus comprising one or more exterior walls, and a first end and a second end; said first end comprising an end wall with an inlet port; said one or more exterior walls further comprising a first activated charcoal filter disposed between said first end and said second end; said one or more exterior walls further comprising a first light source, said first light source being disposed between said first activated charcoal filter and said second end, said first light source emitting light at wavelengths of less than or equal to 242.3 nm to cause dissociation of contaminant molecules to create ozone and remaining atoms; said one or more exterior walls further comprising a second activated charcoal filter, said second activated charcoal filter being disposed between said first light source and said second end, said second activated charcoal filter acting to filter said remaining atoms; said second activated charcoal filter also permitting atomic rearrangement of ozone into oxygen molecules; said one or more exterior walls further comprising a second light source, said second light source being disposed between said second activated charcoal filter and said second end, said second light source emitting light at wavelengths greater than 242.3 nm but less than 280 nm to cause conversion of ozone into oxygen; said one or more exterior walls further comprising a third activated charcoal filter, said third activated charcoal filter being disposed between said second light source and said second end, said third activated charcoal filter acting to further filter said remaining atoms; said second end comprising a wall with an outlet port.

21. The apparatus for purifying air according to claim 20 wherein said one or more exterior walls comprises a cylindrical-shaped wall.

22. The apparatus for purifying air according to claim 20 wherein said one or more exterior walls comprises four orthogonal walls that form a rectangular cross-section.

23. A method of purifying air comprising the steps of:
(a) passing contaminated air through an activated charcoal filter;
(b) illuminating the air using a light source emitting wavelengths of light that are less than 242.3 nm to cause dissociation of contaminant molecules into ozone and remaining atoms;
(c) passing the air flow through a second activated charcoal filter to permit molecular rearrangement of said ozone into oxygen molecules, and to scrub said remaining atoms from the air flow;
(d) illuminating the air flow using a light source that emits wavelengths of light that are greater than 242.3 nm but less than 280 nm, to cause conversion of said ozone into oxygen molecules;
(e) passing the air flow through an activated charcoal filter.
